(19) United States
(12) Patent Application Publication
(10) Pub. No.: US 2015/0295310 A1
(43) Pub. Date: Oct. 15, 2015

(54) Adaptive Donor Antenna

(71) Applicant: Optical Cable Corporation, Roanoke, VA (US)

(72) Inventors: G. Thomas Hazelton, Plano, TX (US); Ian J. Timmins, Asheville, NC (US)

(21) Appl. No.: 14/685,197

(22) Filed: Apr. 13, 2015

Related U.S. Application Data
(60) Provisional application No. 61/978,274, filed on Apr. 11, 2014.

(51) Int. Cl. H01Q 3/36; H04B 7/06

(52) U.S. Cl. CPC H01Q 3/36; H04B 7/0617

(57) ABSTRACT

An adaptive donor antenna system including at least one antenna array being structured and disposed for generating a radio frequency beam pattern for receiving and repeating a data transmission signal; a sensor device that is structured and disposed for measuring the strength of the data transmission signal; a microcontroller in communication with the sensor device, and the microcontroller being structured and disposed for dynamically steering the radiation pattern of the at least one antenna array in the direction of the strongest data transmission signal as measured by the sensor device; and a phase shifter in communication with the at least one antenna array and the microcontroller, and the phase shifter being structured and disposed for adjusting the radio frequency beam pattern of the at least one antenna.

### BACKGROUND OF THE INVENTION

This application is based on and claims priority to provisional patent application No. 61/978,274 filed on Apr. 11, 2014.

### FIELD OF THE INVENTION

This disclosure relates to the field of steered antenna arrays using phase shift control bits to adjust the radiation pattern of a donor antenna.

### DISCUSSION OF THE RELATED ART

Donor antennas are essential for maximizing signal and coverage strength in in-building wireless systems. Standard donor antennas provide either (1) a directional radiation pattern or (2) an omni-directional radiation pattern, each having respective advantages and disadvantages. While the directional radiation pattern of a steered antenna array has a relatively high gain for acquiring a weak signal in the established direction, there is little to no gain in other surrounding directions. Conversely, omni-directional radiation patterns have 360 degree coverage; however, omni-directional antennas have lower gain across the 360 degree field and, however, can often It in signal interference with other antennae. The most common method for limiting signal interference is separating the otherwise overlapping signals using a signal obstructing structure, e.g., concrete.

In light of the above, there exists a need for a donor antenna capable of dynamically adjusting a directional radiation pattern in order to acquire the strongest signal within range.

### SUMMARY OF THE INVENTION

The present invention is directed to an adaptive beam-fore ling donor antenna array to be used for the improvement of in-building wireless systems subject a changing service provider footprint, such that a different propagation angle of arrival may provide better quality of service at various periods of time.

This system is designed to be used seamlessly with conventional in-building wireless enhancement components, such as bi-directional amplifiers and coaxial or fiber optic cabling systems. The system may also consist of multiple antenna arrays for various frequency bands used for communications from within the building structure.

In one embodiment of the present invention there is provided an adaptive donor antenna system including at least one antenna array being structured and disposed for generating a radio frequency beam pattern for receiving and repeating a data transmission signal; a sensor device that is structured and disposed for measuring the strength of the data transmission signal; and a microcontroller in communication with the sensor device, and the microcontroller being structured and disposed for dynamically steering the radiation pattern of the at least one antenna array in the direction of the strongest data transmission signal as measured by the sensor device.

In another form of the present invention there is provided an adaptive donor antenna system including a plurality of antenna arrays being structured and disposed for generating a radio frequency beam pattern for receiving and repeating a data transmission signal; a sensor device that is structured and disposed for measuring the strength of the data transmission signal; and a microcontroller in communication with the sensor device, and the microcontroller being structured and disposed for dynamically steering the radiation pattern of each of the plurality of antenna arrays in an optimal direction for receiving the strongest data transmission signal as measured by the sensor device.

In yet another form of the present invention there is provided an adaptive donor antenna system for use in comb nation with a plurality of data transmission signals, and the adaptive donor antenna system including a plurality of antenna arrays being structured and disposed for generating a radio frequency beam pattern for receiving and repeating one of the plurality of data transmission signals; a sensor device that is structured and disposed for measuring the strength of the plurality of data transmission signals; a phase shifter in communication with the plurality of antenna arrays, and the phase shifter being structured and disposed for adjusting the radio frequency beam pattern of each of the plurality of antenna arrays; and a microcontroller in communication with the sensor device and phase shifter, and the microcontroller being structured and disposed for dynamically steering the radiation pattern of each of the plurality of antenna arrays in an optimal direction for receiving the strongest data transmission signal as measured by the sensor device and sending a signal to the phase shifter for adjusting, the radio frequency beam pattern of each of the plurality of antenna arrays to an optimal position for optimizing communication with he stronger one of the plurality of data transmission signals.

### BRIEF DESCRIPTION OF THE DRAWINGS

FIG. 1 is a schematic diagram showing the external donor antenna system of the present invention in an in-building wireless enhancement system in which an external antenna is placed in such a manner that it has maximum signal strength to multiple provider towers in proximity to the building;

FIG. 2 is a schematic diagram showing a Tower ‘A’ interacting with mobile users and in-building wireless enhancement (RN) systems simultaneously and further illustrates that at some later time due to changes in operating effectiveness of Tower ‘A’ it may be advantageous to redirect signals from within the building to Tower ‘B’.

FIG. 3 is a schematic diagram showing an adaptive antenna including multiple antenna arrays, with individual sense circuitry and beam steering mechanism for each pertinent frequency band and further illustrates that the bands are then combined together for entry into the conventional in-building RF cable transport system;

FIG. 4A is a schematic diagram showing an omni-directional radiation pattern as per a typical, donor antenna based, in-building wireless communications enhancement system and illustrates that the radiation is approximately equal in all directions around the perimeter of the installed antenna.

FIG. 4B is a schematic diagram showing a radiation pattern of a steered antenna array, showing higher gain in the 0 degree direction; and

FIG. 5 is a schematic diagram showing microcontroller at the center of the steering of the antenna beam, a phase shifter for providing a digital means change in the electrical delay of the signal delivered to each antenna, an integrated GPS receiver, and a radio frequency sensor.

Like reference numerals refer to like parts throughout the several views of the drawings.

### DETAILED DESCRIPTION OF THE PREFERRED EMBODIMENTS

Referring to the several views of the drawings, the adaptive donor antenna system of the present invention for use in conjunction with an in-building 100 wireless system and described herein is shown and is generally indicated as 10.

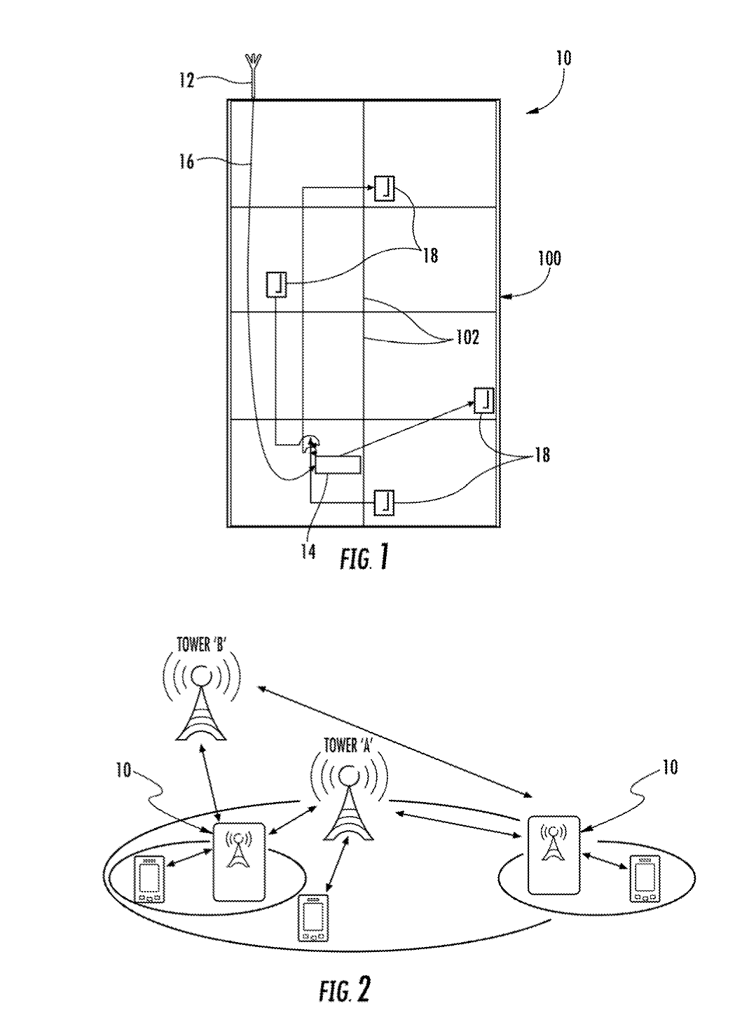

An adaptive donor antenna system 10 is used at the donor antenna position of a distributed antenna system for the purpose of dynamic adjustment of the donor antenna radiation pattern. The radiation pattern from the donor antenna 12 or antenna array compensates for changes in a cell tower footprint from wireless communications provider's network. The radiation pattern of the donor antenna can be adjusted for higher gain in different spatial directions to account for measured power and subsequent quality of service from respective towers in different locations. In other words, the radiation pattern, optionally transmitting and receiving signals to and from selective base station towers (e.g., Tower's ‘A’ and B′ on FIG. 2), can be adjusted when one base station tower is deemed more desirable than an alternate tower.

The selection of the appropriate communications path and associated radiation pattern from the donor antenna 12 is made by considering the power and signal quality of the actual data signal received from the base station tower, as opposed to relying upon a separate pilot signal or reference signal transmitted from the base station tower. In this sense, the antenna 12 and associated microcontroller 20 disclosed herein provide ad hoc adjustment of the radiation pattern so that the donor antenna 12 directs its communications protocol to optimize communications with the signals from the strongest sources of the transmission. In other words, this disclosure explains how the gain of the antenna 12 may be steered mechanically or electrically to optimize transmission efficiency when the antenna 12 is capable of communicating with select base station towers.

Referring to FIGS. 1 and 2, an adaptive donor antenna system 10 is shown in conjunction with an in-building 100 wireless enhancement system covering multiple floors/rooms 102 in which at least one external donor antenna 12 is placed in such a manner that it has maximum signal strength to multiple provider towers in proximity of the building 100. FIG. 1 shows the donor antenna 12 in connection with a bi-directional amplifier 14 via RF cable 16, which is in communication with a plurality of internal antennae 18. FIG. 2 illustrates a Tower ‘A’ that interacts with mobile users and in-building wireless enhancement (RN) systems simultaneously and further illustrates that at some later time, due to changes in operating effectiveness of Tower ‘A’, it may be advantageous to redirect signals from within the building to Tower ‘B’ using the adaptive donor antenna system 10.

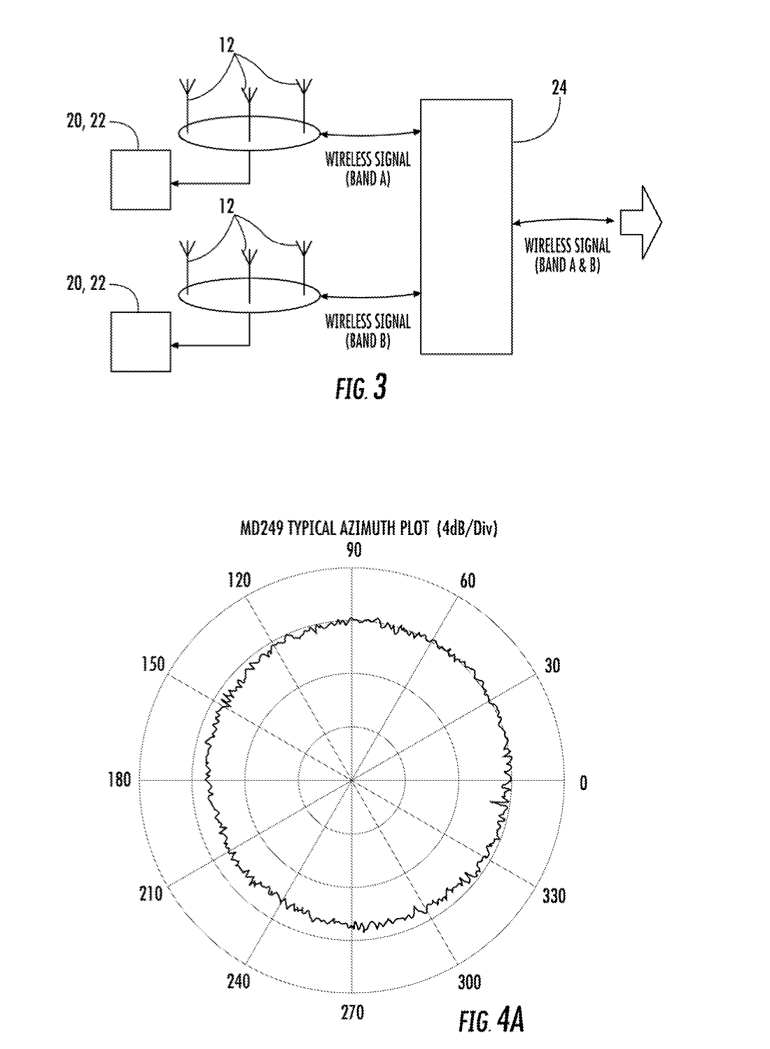

Referring to FIG. 3, the adaptive donor antenna system 10 may include an adaptive antenna 12 having multiple antenna arrays, with a microcontroller 20 and radio frequency sensor 22 having individual sense circuitry and beam steering mechanisms for each pertinent frequency band and further illustrates that the bands are then combined together by a frequency band isolator 24 for into the conventional in-building RF cable transport system.

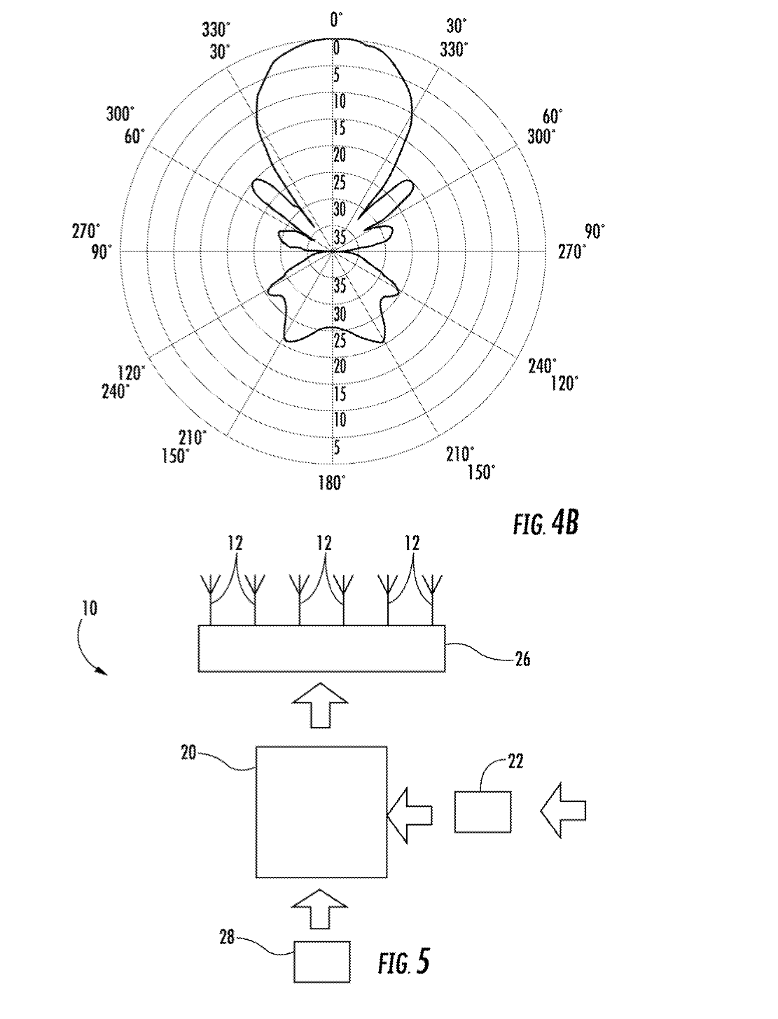

Referring to FIGS. 4A and 4B, omni-directional and steered directional radiation patterns are shown, respectively. As illustrated in FIG. 4A, an omni-directional radiation pattern as per a typical, donor antenna based, in-building wireless communications enhancement system is approximately equal in all directions around the perimeter of the installed antenna. Conversely, as illustrated in FIG. 4B, a radiation pattern of a steered antenna array shows higher gain in the 0 degree direction and illustrates that this radiation pattern may be adjusted at a later point in time should it be determined that 0 degrees is no longer the optimum configuration as a result of operational changes in the wireless provider's cell tower configuration.

In particular, the radiation pattern may be adjusted to accommodate different towers on different channels in the same frequency band, and not steer the antenna 12 to one tower exclusively. The antenna 12 may consist of several distinct antenna arrays for different frequency bands collectively, operating independently of each other from a control perspective, but all functioning as a single donor antenna for an in-building wireless system, In one embodiment, a single microcontroller 20 may be utilized to check the transmission quality and optimize received signals in a variety of frequency bands (e.g., 700 MHz, 800 MHz, 1900 MHz, 2.5 MHz, 2.1 MHz, and 1.7 MHz).

In one embodiment, the system 10 includes an antenna array (possibly multiple, as in tour antennae 12), a method of measuring received power or estimating quality of service from a data transmission signal received from a base station tower, and a controlling mechanism to dynamically steer the radiation pattern based on those measurements. The system 10 is capable of processing and repeating bi-directional radio frequency presented to the system 10 within a digital (or analog) envelop of information. The system 10 is capable of aggregating carriers within different frequency hands to radiate contiguous carriers of spectrum to an in-building wireless system from a donor antenna array 12. The system 10 is further capable of recording or logging any changes related to radiation events into data storage for processing. The recording or logging information can be used to predict optimal usage times and to provide estimates of which base station tower provides the best service and data transmission signal at times of the day.

A donor antenna 12 can be used with a single or multiple bi-directional amplifiers, or any other RF transport system designed to enhance in-building wireless communications. Accordingly, this technique can be used to improve either coverage range or bit-per-second/Hz available to the mobile user.

Referring to FIG. 5, the microcontroller 20 is at the center of the steering of the antenna beam and shows that to control the donor antenna radiation pattern, beam-forming techniques are used with phase shifters 26. A phase shifter 26 provides a digital means change in the electrical delay of the signal delivered to each antenna, arid thereby causes a change in the collective signals of all antenna elements radiating together. The received RF signal can be adjusted based on direct measurement of the RF power by an RF sensor 22. In one embodiment, an ASIC (Application Specific Integrated Circuit) is used for specific measurement of signal as the beam-forming array is steered in different directions. The measurer e he power as the beam-forming array hunts for the likely direction of the provider base station tower is done by the microcontroller 20, and then adjustment of the phase shifters 26 by the microcontroller 20 thereafter.

Referring still to FIG. 5. a GPS receiver 28 can also be integrated into the system and monitored by the microcontroller 20 to assist in tower location by having a database of base station tower positions and accessing data via the internet to favor directions of provider towers in relation to the donor antenna's known self-position.

While the present invention has been shown and described in accordance with several preferred and practical embodiments, it is recognized that departures from the instant disclosure are contemplated within the spirit and scope of the present invention which are not limited except as defined in the following claims as interpreted by the Doctrine of Equivalents.

What is claimed is:

1. An adaptive donor antenna system comprising:
at least one antenna array being structured and disposed for generating a radio frequency beam pattern for receiving and repeating a data transmission signal;
a sensor device that is structured and disposed for measuring the strength of the data transmission signal; and
a microcontroller in communication with said sensor device, and said microcontroller being structured and disposed for dynamically steering the radiation pattern of said at least one antenna array in the direction of the strongest data transmission signal as measured by said sensor device.

2. The adaptive donor antenna system as recited in claim 1 further comprising a phase shifter in communication with said at least one antenna array and said microcontroller, and said phase shifter being structured and disposed for adjusting the radio frequency beam pattern of said at least one antenna array; and
wherein said microcontroller sends a signal to said phase shifter or adjusting the radio frequency beam pattern of said at least one antenna array to an optimal position.

3. The adaptive donor antenna system as recited in claim 1 wherein said sensor device is a radio frequency sensor.

4. The adaptive donor antenna system as recited in claim 1 further comprising a global positioning system for receiving and storing positional data of the data transmission signals.

5. An adaptive donor antenna system comprising:
a plurality of antenna arrays being structured and disposed for generating a radio frequency beam pattern for receiving and repeating a data transmission signal;
a sensor device that is structured and disposed for measuring the strength of he data transmission signal; and
a microcontroller communication with said sensor device, and said microcontroller being structured and disposed for dynamically steering the radiation pattern of each of said plurality of antenna arrays in an optimal direction for receiving the strongest data transmission signal as measured by said sensor device.

6. The adaptive donor antenna system as recited in claim 5 further comprising a phase shifter in communication with each of said plurality of antenna arrays and said microcontroller, and said phase shifter being structured and disposed for adjusting the radio frequency beam pattern of each of said plurality of antenna arrays; and
wherein said microcontroller sends a signal to said phase shifter for adjusting the radio frequency beam pattern of each of said plurality of antenna arrays to an optimal position.

7. The adaptive donor antenna system as recited in claim 5 wherein said sensor device is a radio frequency sensor.

8. The adaptive donor antenna system as recited in claim 5 further comprising a global positioning system for receiving and storing positional data of the data transmission signals.

9. An adaptive donor antenna system for use combination with a plurality of data transmission signals, and said adaptive donor antenna system comprising:
a plurality of antenna arrays being structured and disposed for generating a radio frequency beam pattern for receiving and repeating one of the plurality of data transmission signals;
a sensor device that is structured and disposed for measuring the strength of the plurality of data transmission signals;
a phase shifter n communication with said plurality of antenna arrays, and said phase shifter being structured and disposed for adjusting the radio frequency beam pattern of each of said plurality of antenna arrays; and
a microcontroller in communication with said sensor device and said phase shifter, and said microcontroller being structured and disposed for dynamically steering the radiation pattern of each of said plurality of antenna arrays in an optimal direction for receiving the strongest data transmission signal as measured by said sensor device and sending a signal to said phase shifter for adjusting the radio frequency beam pattern of each of said plurality of antenna arrays to an optimal position for optimizing communication with the stronger one of the plurality of data transmission signals.

10. The adaptive donor antenna system as recited in claim 9 further comprising a phase shifter in communication with each of said plurality of antenna arrays and said microcontroller, and said phase shifter being structured and disposed for adjusting the radio frequency beam pattern of each of said plurality of antenna arrays; and
wherein said microcontroller sends a signal to said phase shifter for adjusting the radio frequency beam pattern of each of said plurality of antenna arrays to an optimal position.

11. The adaptive donor antenna system as recited in claim 9 wherein said sensor device is a radio frequency sensor.

12. The adaptive donor antenna system as recited in claim 9 further comprising a global positioning system for receiving and storing positional data of the data transmission signals.
